(19) United States
(12) Patent Application Publication
(10) Pub. No.: US 2025/0316054 A1
(43) Pub. Date: Oct. 9, 2025

(54) METHOD AND ELECTRONIC DEVICE FOR DETERMINING SINGLE-PHOTON EMITTER BASED ON DEEP LEARNING

(71) Applicant: GWANGJU INSTITUTE OF SCIENCE AND TECHNOLOGY, Gwangju (KR)

(72) Inventors: Sangyun Lee, Gwangju (KR); Seoyoung Paik, Gwangju (KR); Dongbeom Kim, Gwangju (KR)

(21) Appl. No.: 18/927,599

(22) Filed: Oct. 25, 2024

(30) Foreign Application Priority Data
Apr. 4, 2024 (KR) 10-2024-0045969

(51) Int. Cl. G06V 10/60; G06V 10/30; G06V 10/72; G06V 10/774; G06V 10/776; G06V 10/82; G06V 20/69; G06V 20/70

(52) U.S. Cl. CPC G06V 10/60; G06V 10/30; G06V 10/72; G06V 10/774; G06V 10/776; G06V 10/82; G06V 20/698; G06V 20/70

(57) ABSTRACT

A method for determining a single-photon emitter based on deep learning, performed by at least one electronic device, may include: acquiring input data based on a single-photon point light source image; generating determination information expected values by inputting the input data to a trained artificial neural network model; and determining whether an emitter providing the single-photon point light source image is a single-photon emitter or a non-single-photon emitter, based on the determination information expected values.

### CROSS-REFERENCE TO RELATED APPLICATIONS

The present application claims priority under 35 U.S.C. 119 and 35 U.S.C. 365 to Korean Patent Application No. 10-2024-0045969 (filed on Apr. 4, 2024), which is hereby incorporated by reference in its entirety.

### BACKGROUND

Embodiments of the present disclosure relate to a method and an electronic device for determining a single-photon emitter based on deep learning.

A point light source refers to a light source that virtually has no area and is composed of a single geometric point. A point light source emits light evenly in all three-dimensional directions from the center of the light source.

Among point light sources, a point light source that emits a single photon at a time is referred to as a single-photon emitter. When single-photon emitters are clustered closely together and the resolution limit of an observation tool (e.g., a microscope, etc.) is greater than the spacing between the single-photon emitters, the corresponding emitter group is a non-single-photon emitter.

Therefore, one single-photon emitter may form a point light source, a plurality of single photon emitters may form a point light source, or a plurality of non-single photon emitters may form a point light source. A point light source capable of emitting a single photon in such a manner is defined as a ‘single-photon point light source’ and is described below.

With the development of quantum information and quantum computing, research into an isolated single-photon emitter that can be used as a qubit, which is a basic unit of quantum information, at room temperature is becoming increasingly important. With the recent development of spin-photon conversion technology, research into single-photon emitters is also considered a very important and core technology in quantum computing network research.

As ion implantation techniques have advanced, point light sources including single-photon emitters maybe artificially generated within a medium with relatively high positional accuracy.

Since the focal volume of an optical measurement tool is incomparably large compared to the physical size of a point light source observed in a specific atomic or molecular system, a plurality of single-photon emitters may exist within the focal volume, and thus, may appear as if they were one point light source. Therefore, it is necessary to determine whether the point light sources seen in optical images are single-photon emitters or non-single-photon emitters.

To definitively prove that the point light sources are single-photon emitters, there is a method for measuring a second-order correlation function (g⁽²⁾(τ)) through a Hanbury Brown-Twiss (HBT) experiment, which analyzes an arrival time interval between photons. At this time, there is an inconvenience that it takes a long time to perform the HBT experiment and measure the second-order correlation function.

### SUMMARY

Embodiments of the present disclosure aim to provide a method and a device capable of increasing time and labor efficiency in finding a single-photon emitter by directly determining whether an emitter is a single-photon emitter or a non-single-photon emitter from a point light source image measured using a deep learning model without conducting a Hanbury Brown-Twiss (HBT) experiment.

A method for determining a single-photon emitter based on deep learning, performed by at least one electronic device, according to an embodiment of the present disclosure may include: acquiring input data based on a single-photon point light source image; generating determination information expected values by inputting the input data to a trained artificial neural network model; and determining whether an emitter providing the single-photon point light source image is a single-photon emitter or a non-single-photon emitter, based on the determination information expected values.

In an embodiment of the present disclosure, the single-photon point light source image may include an image acquired using confocal fluorescence microscopy, scanning tunneling microscopy (STM), and/or nanoscale-magnetic resonance imaging (nano-MRI).

In an embodiment of the present disclosure, the single-photon point light source may include at least one of isolated single atoms, single molecules, single dye molecules, and/or point defects in solids.

In an embodiment of the present disclosure, the input data may be generated based on an image of a small area having a photon count rate of a preset standard within a preset area in a large-scan image including one single-photon point light source cluster.

In an embodiment of the present disclosure, the method may further include training the artificial neural network model, wherein the training of the artificial neural network model may include constructing image training data based on the single-photon point light source image.

In an embodiment of the present disclosure, the training of the artificial neural network model may further include constructing laser power training data based on laser power irradiated on a target sample.

In an embodiment of the present disclosure, the constructing of the image training data may include:

generating an image of a small area having a photon count rate of a preset standard within a preset area in a large-scan image including one single-photon point light source cluster; removing background noise from the generated image; determining and labeling whether the emitter is the single-photon emitter or the non-single-photon emitter; and performing normalization to a normally distributed value.

In an embodiment 4 the present disclosure, the generated image may include an image focused on an individual emitter, and

the image focused on the individual emitter may be an image of a small area raster-scanned again based on a pixel corresponding to a local maximum of a photon count rate of the individual emitter in a raster-scanned image for the individual emitter within the one single-photon point light source cluster.

In an embodiment of the present disclosure, the trained artificial neural network model may include a convolutional neural network (CNN)-based deep learning model.

In an embodiment of the present disclosure, the trained artificial neural network model may include a convolutional layer, a pooling layer, and/or a fully-connected layer.

In an embodiment of the present disclosure, the trained artificial neural network model may include: a first learning model that is distinguished according to a correlation between the input data and the laser power irradiated on the target sample; and a second learning model that is not distinguished according to the correlation between the input data and the laser power irradiated on the target sample.

In an embodiment of the present disclosure, the trained artificial neural network model may be trained using a binary cross-entropy loss function.

In an embodiment of the present disclosure, the trained artificial neural network model may determine whether the determination information expected values are appropriate by using K-fold cross validation, where k is a natural number greater than or equal to 3, and

the K-fold cross validation may be performed by randomly classifying training data into k-folds and using k−1 folds as a training set and the remaining one fold as a testing set.

An electronic device for determining a single-photon emitter based on deep learning according to an embodiment of the present disclosure may include: at least one memory; and at least one processor configured to: acquire input data based on a single-photon point light source image; generate determination information expected values by inputting the input data to a trained artificial neural network model; and determine whether an emitter providing the single-photon point light source image is a single-photon emitter or a non-single-photon emitter, based on the determination information expected values.

In an embodiment of the present disclosure, there is provided a computer program stored in a storage medium, the computer program for causing at least one processor to perform operations for determining a single-photon emitter based on deep learning, the operations including: acquiring input data based on a single-photon point light source; generating determination information expected value by inputting the input data to a trained artificial neural network model; and determining a single-photon emitter or a non-single-photon emitter, based on the determination information expected value.

Other aspects, features, and advantages of the disclosure will become better understood through the accompanying drawings, the appended claims, and the detailed description.

According to an embodiment of the present disclosure, the single-photon emitter can be effectively found from the single-photon point light source image using the trained artificial neural network without conducting an HBT experiment, thereby increasing time and labor efficiency.

In addition, according to an embodiment of the present disclosure, the small-area image including the emitter can be obtained from the scan image of the large area at an appropriate focal distance, and whether the emitter is the single-photon emitter can be determined, thereby increasing time efficiency.

### BRIEF DESCRIPTION OF THE DRAWINGS

FIGS. 1A-1E are diagrams for organizing the concept related to an experiment of the present disclosure and describing the effects of the present disclosure.

FIGS. 2A and 2B are diagrams showing an experimental equipment of the present disclosure and an image of a diamond center NV array.

FIG. 3 is a configuration diagram of an electronic device according to an embodiment of the present disclosure.

FIGS. 4 to 6 are flowcharts for describing a method for determining a single-photon emitter based on deep learning according to an embodiment of the present disclosure.

FIG. 7 is a diagram showing an example of a convolutional neural network (CNN)-based deep learning model designed according to the present disclosure.

FIG. 8 is a diagram showing an example of a K-fold cross validation method applied to the present disclosure.

FIGS. 9A and 9B are graphs showing result values of loss functions of a training set and a testing set in each fold according to an epoch when evaluating a deep learning model of the present disclosure.

FIG. 10 is a diagram showing some emitter images among images focused on individual emitters.

FIGS. 11A-11D are graphs showing the distribution of data determination results of a deep learning model of the present disclosure and the accuracy ratio thereof.

FIG. 12 is a diagram showing an actual single-photon emitter and a single-photon emitter expected by a deep learning model.

FIG. 13 is a diagram showing a final output of a CNN layer in a case where the determination for representative data succeeds and a case where the determination for representative data fails.

### DETAILED DESCRIPTION OF THE EMBODIMENTS

Hereinafter, embodiments of the present disclosure will be described in detail with reference to the accompanying drawings. When describing embodiments with reference to the accompanying drawings, the same or corresponding elements are denoted by the same reference numerals, and redundant descriptions thereof are omitted.

In the following embodiments, the terms “first,” “second,” etc. are not used in a restrictive sense and are used to distinguish one element from another.

The singular forms as used herein are intended to include the plural forms as well unless the context clearly indicates otherwise.

It will be further understood that the terms “include” and/or “comprise” used herein specify the presence of stated features or elements, but do not preclude the presence or addition of one or more other features or elements.

### Introduction

In the present disclosure, a ‘single-photon point light source’ refers to a point light source including a plurality of single-photon emitters as a special example among point light sources. The ‘single-photon point light source’ may include (photon) emitters that emit photons and may detect single-photon emitters among them.

An isolated single-photon emitter may be used as a qubit, which is a basic unit of quantum information. The single-photon point light source may include isolated single atoms, single molecules, single dye molecules, point defects in solids, etc. The point defects in solids may include color centers in diamond, silicon vacancy in SiC, quantum dots, carbon nanotubes, etc. Here, the color centers in diamond may include a diamond NV center, a diamond SiV center, a diamond ST1 center, etc.

The search and determination of single-photon emitters is an important process that must be preceded in experiments. Single-photon emitters may be determined through images obtained using confocal fluorescence microscopy that can focus on a volume of several hundred nanometers in size, scanning tunneling microscopy (STM) that is capable of imaging in atomic sizes, or nanoscale-magnetic resonance imaging (nano-MRI).

To definitively prove that the point light sources are single-photon emitters, a second-order correlation function (g⁽²⁾(τ)) is measured through a Hanbury Brown-Twiss (HBT) experiment and antibunching (g⁽²⁾(0)=0) is verified. However, in real experiments, it is difficult to observe ideal antibunching due to factors such as stray photons, scattering in medium, and detector dark counts. Accordingly, when the measured g⁽²⁾(τ) is greater than or equal to 0 and less than the case where two photons are emitted (0≤g⁽²⁾(0)<0.5), it is determined as a single-photon emitter. However, this process may have a lot of noise depending on real experimental environments, and thus, it takes a long time to obtain a sufficiently high signal-to-noise ratio.

Alternatively, when a color center with well-known photon emission characteristics is analyzed using a well-tested experimental equipment, the determination may be performed by measuring a maximum photon emission rate, i.e., a saturated count rate. However, in this case as well, since the measurement must be made while changing an optical pumping rate, a repetitive measurement process is required.

Moreover, since it is easy to artificially generate a single-photon point source, numerous emitters can be generated within a target sample. The process of analyzing each emitter to reliably identify single-photon emitters is a very time-consuming task, even if automated. For this reason, research has been conducted to efficiently analyze and determine g⁽²⁾(τ), and it is necessary to find a method to perform determination without conducting an HBT experiment so as to dramatically improve efficiency.

Therefore, in embodiments of the present disclosure, studies have been conducted on single-photon emitter determination that can be performed using only a single-photon point light source (diamond NV center) image by introducing deep learning without conducting an HBT experiment.

### 2. RELATED CONCEPTS

### 2.1. Diamond NV Center (NV Center in Diamond as a Model Single-Photon Emitter)

In an embodiment of the present disclosure, a diamond NV center was used as a single-photon point light source. The ‘diamond NV center’ is one of point defects composed of a nitrogen impurity and a carbon vacancy in the diamond. The diamond NV center is an emitter, of which a photon emission probability is highly dependent on an electron spin state. Due to such characteristics, the diamond NV center may be used as a single-photon emitter and also used to develop various quantum information technologies, including quantum communication, quantum sensing, and quantum computing, by employing a ground state electron spin as a qubit, which is a basic unit of a quantum computer.

### Embodiment 1: Diamond NV Center

The diamond NV center exists in two charge states: NV0 and NV-. In this research, NV- has been used. The spectrum of photons emitted from NV-forms a 200 nm wide phonon-side band centered around 700 nm at room temperature. Since the diamond NV center is used as a single-photon emitter, it is unnecessary to consider electron spin and spin-dependent photon emission. Thus, the diamond NV center is considered as a three-level system including a ground state, an excited state, and a metastable state.

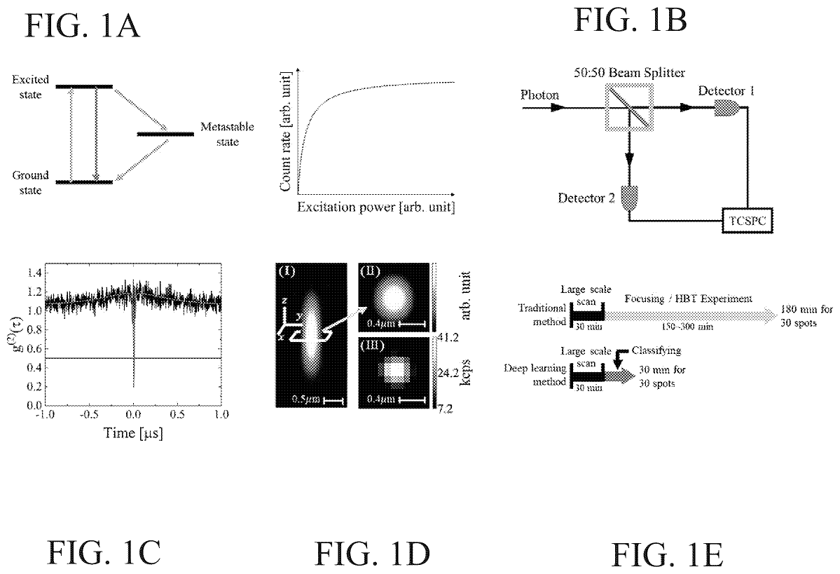

Referring to FIG. 1A, in a three-level system light source, when an optical pumping rate increases, the probability of photon emission also rises before reaching saturation.

### 2.2. Second-Order Correlation Function

A method for identifying a single-photon emitter involves measuring the second-order correlation function using an HBT configuration. The HBT experiment depicted in FIG. 1B records an event in which, after photons emitted from a light source pass through beam splitters with the same transmittance and reflectivity, photon is detected at one of two output ports of the beam splitter and second photon is detected at the other output port after a certain period of time. From this, the second-order correlation function defined as in Equation 1 is obtained.

$${g}^{( 2 )} ( τ ) = \frac{〈 n ( t ) n ( t + τ ) 〉}{〈 n ( t ) 〉 〈 n ( t + τ ) 〉} \qquad [ Equation 1 ]$$

where t is the time at which the photon is detected, τ is the time interval between two photon measurement events, and n(t) is the number of photons measured at t. In the case of an ideal single-photon emitter, two photons cannot be detected simultaneously, and thus, antibunching where g⁽²⁾(0)=0 is observed.

Meanwhile, in the case of a light source that emits N photons simultaneously, g⁽²⁾(0)=1−1/N, and when N=2, g⁽²⁾(0)=0.5. In real experimental environments, a finite background is always detected due to scattering of a pump beam within a medium, stray light, and detector dark count. Therefore, it is difficult to observe ideal antibunching even for single-photon emitters. Therefore, in this research, when 0 g⁽²⁾(0)<0.5, it is determined to be a single-photon emitter.

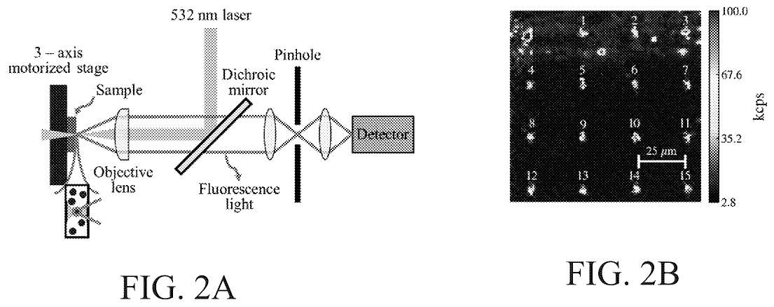

FIG. 1C shows a typical g⁽²⁾(τ) function of the diamond NV center measured in an experimental equipment (see FIG. 2A) to be described below. A sufficiently long period of data accumulation is required to obtain a sufficient signal-to-noise ratio (SNR) so as to determine g⁽²⁾(0)<0.5. When the experimental equipment (see FIG. 2A) to be described below is used to obtain data at a level where 0.5−g⁽²⁾(0) is more than twice an error as in FIG. 1C, it takes about 5-10 minutes. Accordingly, a very long experimental time is required to determine a plurality of emitters (see FIG. 1E).

### 2.3. Point Spread Function (PSF)

As described above, the determination of the single-photon emitter using HBT experiments requires a long period of data accumulation. Accordingly, this study aims to perform determination through emitter images (including irradiated laser power) using deep learning.

The image acquired in this study is acquired using confocal fluorescence microscopy to be described below and corresponds to one intercept of the point spread function (PSF) of the single-photon emitter in an ideal experimental environment. The PSF is a function that describes how light spreads across a focal plane when light other than a point light source is captured by an optical system. The PSF is determined by characteristics of the optical system, etc., In the case of an ideal optical system as shown in FIG. 1D, the two-dimensional PSF appears as an Airy function on the focal plane, and the three-dimensional PSF additionally expresses the distribution of light according to the depth of the image plane. In the case of the two-dimensional PSF, when the light source is distributed on a plane as f(x, y), the acquired image can be expressed as the convolution of the PSF thereof and f(x, y), as in Equation 2 below.

$$( f * P S F ) ( x , y ) = {\int }_{- ∞}^{∞} {\int }_{- ∞}^{∞} f ( α , β ) P S F ( x - α , y - β ) d α d β \qquad [ Equation 2 ]$$

When using a typical diffraction-limited confocal fluorescence microscope, the boundary of the PSF is determined as the position where the intensity falls to 1/e. At this time, the radius of the PSF is determined as r=0.61λ/NA, where λ is a wavelength of the light source and NA is a numerical aperture of an objective lens of the optical system.

For the diamond NV center used in this study, λ=700 nm, and for the confocal fluorescence microscopy setup used, the objective lens has NA=0.95. Accordingly, the radius of the confocal volume is r≅400 nm.

Since the physical size of the point light source such as the diamond NV center is close to the atomic size, the acquired image approaches the perfect PSF. The radius measured for the acquired image is very close to the radius of the PSF verified experimentally in FIG. 1D, it can be seen that the confocal fluorescence microscopy setup used in this study is close to the diffraction-limit. As can be seen in Equation 2, when a plurality of point light sources overlap and the spacing thereof is very small compared to r, the acquired image is similar to the PSF of the single light source, making it difficult for humans to distinguish between the point light sources. Additionally, the images acquired in real experiments are bound to differ from the ideal PSF due to various errors in the imaging system. However, at the same time, it suggests that if images are acquired in real experiments, it may be possible to determine whether the emitters are single-photon emitters through appropriate computational image processing.

### 2.4. Diamond NV Center Image Acquisition Experimental Equipment (Sample Preparation and Experimental Setup)

In the present disclosure, the ‘single-photon point light source’ refers to a point light source including a single-photon emitter that emits single photon. Details of the single-photon point light source are described in section 1. In an embodiment of the present disclosure, a diamond NV center was used as a single-photon point light source.

In the present disclosure, the ‘single-photon point light source image’ refers to an image from which single-photon point light sources are observed. The ‘single-photon point light source image’ may be observed as a plurality of isolated point light sources that are distinguishable from each other or as a cluster of point sources that are too close to each other or overlap each other to be distinguished from each other. Therefore, the generated ‘single-photon point light source image’ is not in the form of a perfect (single) point light source in most cases, and the number and distribution of individual point light sources included in the single-photon point light source can be identified by generating a high-resolution image and conducting additional experiments.

Additionally, the ‘single-photon point light source image’ may include a cluster including a plurality of emitters. Here, the emitter is an isolated, individual light-emitting area.

In the present disclosure, a single-photon point light source array′ refers to a form in which clusters including a plurality of emitters are regularly arranged on a two-dimensional plane. A spot may include a cluster of at least one emitter, which is included in a particular individual (single-photon point light source) cluster.

In the present disclosure, the ‘confocal fluorescence microscopy’ can generate a high-resolution optical image with improved resolution by removing out-of-focus light through a pinhole and selectively detecting focused light. The ‘confocal fluorescence microscopy’ uses a focused laser beam to scan an entire target sample to excite fluorophores within the target sample.

In the present disclosure, ‘raster scan’ systematically illuminates and detects light at multiple points within a target sample to generate a detailed, high-resolution image. The target sample is scanned point by point in a systematic pattern (e.g., a grid), a laser beam moves across the target sample and the fluorescence emitted at each point is detected through a pinhole.

Most of the emitters observed in the embodiments of the present disclosure are actual point light sources that are physically close to atomic size. However, the resolution limit of the confocal fluorescence microscopy, which is the observation tool, is large compared to the emitter, and thus, if the emitter is not a well-isolated point light source, a plurality of point light sources are observed simultaneously when measuring the images of single-photon point light sources. Therefore, in this case, it is observed as a random distribution image rather than an ideal point source distribution image (PSF). If the observation tool is not optimally prepared or is influenced by nearby emitters, the observed image may be severely distorted and deviate from the ideal PSF when the emitter is an isolated single-photon emitter in reality. Also, although it is a non-single-photon emitter in which a plurality of single-photon emitters overlap, the measured image may appear similar to the PSF of the single-photon emitter because the light intensity is small.

Therefore, in an embodiment of the present disclosure, when analyzing single-photon point light source images showing various shapes, it is possible to determine whether the point light sources are non-single-photon emitters irregularly clumped together or isolated single-photon emitters through a deep learning model, without additional experiments.

### Embodiment 2: Experimental Equipment for Acquiring Diamond NV Center Images

FIG. 2A shows a simplified structure of a confocal fluorescence microscope.

As shown in FIG. 2A, a home-built confocal fluorescence microscope was used to explore single-photon emitters within a diamond sample. The diamond sample was mounted on a piezo scanner capable of 1 nm movements in three dimensions. A 532 nm laser beam is reflected by a 600 nm long pass dichroic mirror, is incident on an objective lens with NA=0.95, and finally irradiates the diamond sample. Light emitted from the single-photon emitter is captured through the same objective lens, and only photons having passed through a 600 nm long pass dichroic filter pass through a pinhole and reach a single-photon detector. A 685 nm long pass filter was additionally installed in front of the photon detector. To ensure a high SNR of an image, photons were collected for 0.1 s per pixel.

After the emitter is identified by confocal fluorescence raster scan, an HBT configuration was set up with a beam splitter placed behind the pinhole for g⁽²⁾(τ) measurement. The experimental equipment of FIG. 2A was used to acquire an image including a diamond NV center array composed of 15 clusters, which is shown in FIG. 2B. FIG. 2B shows a total of 15 clusters, and an average of 25 emitter images were extracted from each cluster to generate training data to be described below.

### 2.5. Data Collection and Preprocessing

In the present disclosure, a ‘focused emitter image’ is an image of a small area acquired by focusing on a pixel corresponding to a local maximum of a photon count rate of an individual emitter in a ‘large-scan image’ acquired by raster-scanning one single-photon point light source cluster and then raster scanning again.

In the present disclosure, a ‘non-focused emitter image or a cropped emitter image’ is an image of a small area cropped based on a pixel corresponding to a local maximum of a photon count rate in a large-scan image. Therefore, the ‘non-focused emitter image’ is an image that is not focused precisely on individual emitters and is a ‘cropped emitter image’ cropped from a large-scan image.

At this time, the large area can be a square area with one side of tens to several tens of μm (e.g., 10 μm×10 μm), and the small area can be a square area with one side of several μm (e.g., 1 μm×1 μm).

In the present disclosure, ‘training data’ for training an artificial neural network model may include ‘image training data’ based on a single-photon point light source image and ‘laser power training data’ based on laser power irradiated on a target sample.

In the present disclosure, ‘image training data’ is generated based on an image of a small area having a set standard photon count rate (related to brightness) within a set area in a large-scan image including one single-photon point light source cluster. A specific process of generating image training data is described below.

In the present disclosure, the ‘laser power training data’ is generated by normalizing the laser power irradiated on a target sample to a normally distributed value when generating a single-photon point light source image. The ‘laser power training data’ is learned in correspondence to the image training data.

### Embodiment 3: Generation of Training Data

In an embodiment of the present disclosure, the image training data may be data generated based on a ‘focused emitter image.’

One of the plurality of diamond NV center clusters generated by irradiating the diamond sample with an ion beam was placed at the center, and a raster scan was performed with the pixel spacing set to 0.1 μm in a 10 μm×10 μm area (large area) to obtain a ‘large-scan image.’ After that, after focusing on the pixel corresponding to the local maximum of the photon count rate of individual emitters, an image of 1 μm×1 μm size (small area) was obtained under the same conditions.

After scanning the xy area centered on individual emitters, the x and y coordinates were fixed at the position indicating the maximum value, and then scanning along the z-axis from that point to find the maximum z value was repeated to obtain an optimal focal length. Images acquired at the optimal focal length are focused emitter images. FIG. 1D(III) shows one of the images acquired in this manner, and learning was performed using data based on these images as described below.

The g⁽²⁾(τ) function of individual emitters distinguishable through this process was measured. If g⁽²⁾(0) was less than 0.5, it was labeled as a single-photon emitter; otherwise, it was labeled as a non-single-photon emitter.

Additionally, a preprocessing process of performing correction by extracting a background count and comparing the background count with the brightness of the emitter to remove the contribution from the background was performed.

In a study related to the present disclosure, there were nine cases where it was impossible to determine g⁽²⁾(0)<0.5 within the error range, and these were excluded from the statistical parameters. Additionally, the power of the laser irradiated on individual emitters was recorded and used for subsequent learning. By repeating this process for the 15 clusters shown in FIG. 2B, image training data including 184 single-photon emitter data and 196 non-single-photon emitter data were obtained.

In order to utilize both images and laser powers with different physical characteristics as training data, both data went through a preprocessing process of standardizing them to the normally distributed values of the data within each characteristic data set so as to acquire final training data. It is shown in Table 1 below.

TABLE 1

| Array | 1 | 2 | 3 | 4 | 5 | 6 | 7 | 8 |
|---|---|---|---|---|---|---|---|---|
| Input power | 0.18 | 0.18 | 0.18 | 0.18 | 0.18 | 0.17 | 0.17 | 0.17 |
| (mW) | | | | | | | | |
| Single data | 10 | 3 | 8 | 12 | 16 | 13 | 13 | 14 |
| Non-single | 13 | 17 | 16 | 19 | 11 | 20 | 8 | 13 |
| data | | | | | | | | |

| Array | 9 | 10 | 11 | 12 | 13 | 14 | 15 |
|---|---|---|---|---|---|---|---|
| Input power | 0.15 | 0.12 | 0.12 | 0.13 | 0.13 | 0.13 | 0.13 |
| (mW) | | | | | | | |
| Single data | 12 | 11 | 14 | 17 | 15 | 11 | 15 |
| Non-single | 9 | 8 | 5 | 11 | 22 | 9 | 15 |
| data | | | | | | | |

The above process corresponds to the data collection and preprocessing process for learning and determining using focused emitter images.

### Embodiment 4: Generation of Image Data (Input Data) for Artificial Neural Network Learning Determination Test

Additionally, it was intended to test the determination of single-photon emitters on a large-scan image (10 μm×10 μm) including one cluster using the trained model. In this case, the process of additionally acquiring focused emitter images can be omitted, which will enable a dramatic reduction in time, as shown in FIG. 1E.

In an image where an arbitrary emitter is focused and a single large area is raster-scanned, not all individual emitters are located on a focal plane. Therefore, if it is possible to determine single-photon emitters from an image where not all emitters are in focus, it may be much more efficient because the experimental time can be reduced. To this end, a plurality of 1 μm×1 μm cropped images centered on the local maximum of the photon count rate (brightness) were obtained from the large-scan image so as to ensure individual emitter images. At this time, in order to avoid determining background noise as the local maximum, only the cases in which the local maximum is different from the minimum of the surrounding eight pixels by more than 4 kcps were classified as the local maximum. The non-focused emitter image (cropped emitter image) obtained in this manner was then used to determine the single-photon emitter through a deep learning model to be described below.

In summary, the diamond NV center image used as input data can be a small-area image (focused emitter image) obtained by observing a part of an area (a square area (small area) with one side of several μm) at high resolution in a large-scan image obtained by observing a square area (large area) with one side of tens of μm, or an image (cropped emitter image) cropped into a square area (small area) with one side of several μm from the large-scan image.

### 3. ELECTRONIC DEVICE

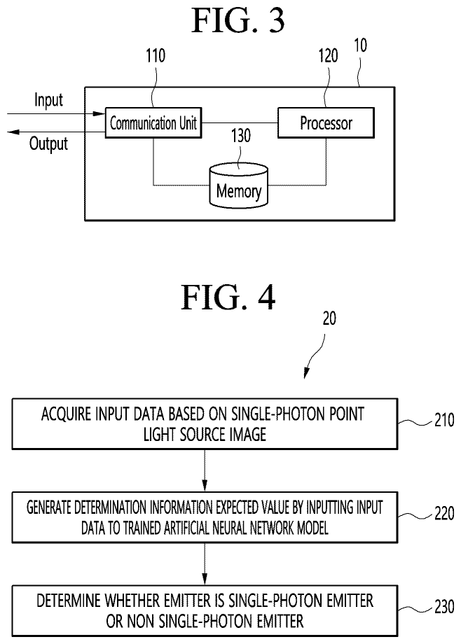

FIG. 3 is a configuration diagram of an electronic device 10 for determining a deep learning-based single-photon emitter according to an embodiment of the present invention.

The electronic device 10 may include at least one communication unit 110, at least one processor 120, and at least one memory 130. The electronic device 10 to which the present disclosure is applied may be an information processing device used by a user. However, the present disclosure is not limited thereto, and the electronic device 10 may further include other elements, or some elements may be omitted.

For example, the electronic device 10 may be a personal computer (PC), a laptop computer, a mobile phone, a tablet PC, a smart phone, a personal digital assistant (PDA), etc.

The communication unit 110 is connected to the processor 120 and the memory 130 to transmit and receive data. The communication unit 110 may be connected to other external devices to transmit and receive data. Hereinafter, the expression that “A” is transmitted and received may mean that “information or data indicating A is transmitted and received”.

The communication unit 110 may be implemented as a circuitry within the electronic device 10. For example, the communication unit 110 may include an internal bus and an external bus. As another example, the communication unit 110 may be an element that connects the electronic device 10 to an external device. The communication unit 110 may be an interface. The communication unit 110 may receive data from an external device and transmit the data to the processor 120 and the memory 130.

The processor 120 may control the overall operation of the electronic device 10 according to an embodiment of the present disclosure and may perform logical operations.

The processor 120 processes data received by the communication unit 110 and data stored in the memory 130. The processor 120 may be a data processing device implemented as hardware having a circuit having a physical structure for executing desired operations. For example, the desired operations may include code or instructions included in a program.

The processor 120 executes computer-readable code (e.g., software) stored in a memory (e.g., the memory 130) and instructions executed by the processor 120.

For example, the processor 120 may acquire input data based on a single-photon point light source image, generate a determination information expected value by inputting the input data to a trained artificial neural network model, and determine a single-photon emitter or a non-single-photon emitter based on the determination information expected value.

The memory 130 stores data received by the communication unit 110 and data processed by the processor 120. The memory 130 may store a program (or an application, software, etc.) that operates the electronic device 10. The stored program may be coded to control the electronic device 10 and may be executable by the processor 120.

The memory 130 may include volatile memory such as static random access memory (RAM) (SRAM), dynamic RAM (DRAM), and synchronous DRAM (SDRAM), or non-volatile memory such as flash memory, phase-change RAM (PRAM), magnetic RAM (MRAM), resistive (RRAM), or ferroelectric RAM (FRAM).

Additionally, in other embodiments, the electronic device 10 may include more elements than those in FIG. 3. For example, the electronic device 10 may further include other elements such as a battery and a charging device that supply power to internal elements, a database, etc.

### 4. METHOD FOR DETERMINING SINGLE-PHOTON EMITTER

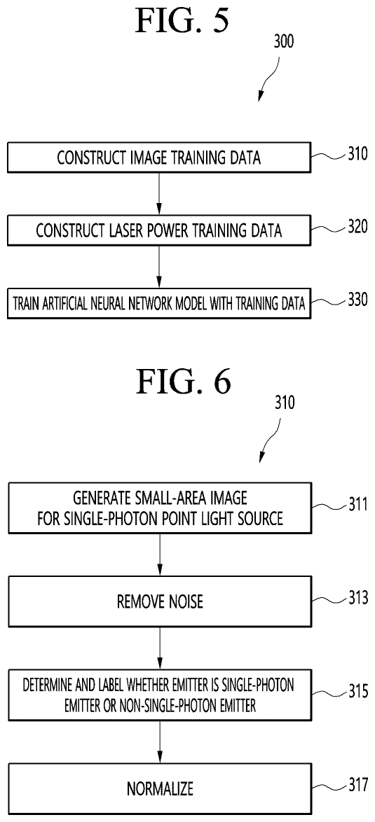

FIGS. 4 to 6 are flowcharts for describing a method 20 for determining a single-photon emitter based on deep learning according to an embodiment of the present disclosure.

Referring to FIGS. 4 to 6, the method 20 for determining a single-photon emitter based on deep learning according to an embodiment of the present disclosure is described.

The following operations 210 to 230 are performed by the electronic device 10 described above.

In operation 210, the electronic device 10 may acquire input data based on a single-photon point light source image.

In an embodiment of the present disclosure, the single-photon point light source image may include an image acquired using confocal fluorescence microscopy, scanning tunneling microscopy (STM), and/or nanoscale-magnetic resonance imaging (nano-MRI).

The input data may be generated based on an image of a small area having a photon count rate of a preset standard within a preset area in a large-scan image including one single-photon point light source cluster.

For example, the operation of acquiring the input data may include generating an image of a small area having a photon count rate of a preset standard within a preset area in a large-scan image including one single-photon point light source cluster, removing background noise from the generated image, and performing normalization to a normally distributed value.

For example, the image of the small area may include a focused emitter image and a non-focused emitter image (cropped emitter image).

The input data generated based on the non-focused emitter image may be acquired in a shorter time than the input data generated based on the focused emitter image because the process of focusing on individual emitters is excluded. Therefore, the experimental time may be efficiently shortened.

In operation 220, the electronic device 10 may generate a determination information expected value by inputting the input data to a trained artificial neural network model.

The artificial neural network model may be a convolutional neural network (CNN)-based deep learning model.

The trained artificial neural network model may include a convolutional layer, a pooling layer, and/or a fully-connected layer, which will be described in detail in the “artificial neural network model construction”.

The determination information expected value is an expected probability including information that may determine whether an emitter is a single-photon emitter or a non single-photon emitter. For example, if the expected probability of being a single-photon emitter is greater than or equal to 0.5, it may be determined as a single-photon emitter, and if less than 0.5, it may be determined as a non-single-photon emitter.

In operation 230, the electronic device 10 may include an operation of determining whether an emitter is a single-photon emitter or a non single-photon emitter, based on the determination information expected value.

Meanwhile, the method for determining a single-photon emitter based on deep learning according to an embodiment of the present disclosure may further include operation 300.

Operation 300 is an operation of training an artificial neural network model.

Operation 300 may include operation 310 of constructing image training data based on a single-photon point light source image.

Operation 310 of constructing image training data may include the following operations.

In operation 311, an image of a small area having a photon count rate of a preset standard within a preset area in a large-scan image including one single-photon point light source cluster may be generated.

For example, an image of a small area may be acquired by focusing on a pixel corresponding to a local maximum of a photon count rate of an individual emitter in a ‘large-scan image’ acquired by raster-scanning one single-photon point light source cluster and then raster scanning again. As described above, the small-area image acquired in this manner may be a ‘focused emitter image’.

In operation 313, background noise is removed from the generated image.

In operation 315, whether the emitter is a single-photon emitter or a non-single-photon emitter may be determined and labeled. Whether the emitter is a single-photon emitter is determined by measuring a second-order correlation function (g⁽²⁾(τ)) using an HBT experiment.

In operation 317, normalization is performed to a normally distributed value.

Through the above operations, image training data may be classified into single-photon emitter data and non-single-photon emitter data.

Operation 300 may include operation 320 of constructing laser power training data based on the laser power irradiated on a target sample.

The laser power training data is generated by normalizing the laser power irradiated on the target sample to a normally distributed value when generating a single-photon point light source image. The laser power training data is learned in correspondence to the image training data.

Additionally, operation 300 may include operation 330 of training the artificial neural network model with the training data.

The artificial neural network model applied herein may be a CNN-based deep learning model. The CNN recognizes unique patterns of images and classifies the images based on the patterns. For example, the CNN may be any one of ALEXNET, ZFNET, VGGNET, GOOGLENET, RESNET, WIDE RESNET, VGG19, INCEPTION V3, INCEPTION V4, XCEPTION, SQUEEZENET, DENSENET, and MOBILENETS.

### 5. CONSTRUCTION OF DEEP LEARNING MODEL

Machine learning is the field of artificial intelligence that creates programs that can classify and predict data by repeatedly learning on their own without being taught the rules of the data one by one. Machine learning has two representative purposes: class classification and regression that predicts specific data values. Deep learning is a sub-concept of machine learning and is a machine learning model that learns data using a neural network method. The neural network includes a layer in which an input is processed, and the layer includes neurons that receive tan input from a previous layer and produces an output. The neurons store intercept values and weight values corresponding to the number of input data.

An activation function is a function that converts the sum of input signals into an output signal, and a loss function is an indicator that represents the difference between a predicted value of a model calculated based on data and an actual value.

In the artificial neural network model, an efficient approximation may be achieved by appropriately adjusting the number of layers, the number of neurons, and the activation and loss functions, and these are hyperparameters that users must appropriately set.

The trained artificial neural network model applied in the present disclosure may be a CNN-based deep learning model. In the present disclosure, the trained artificial neural network model may include a convolutional layer, a pooling layer, and a fully-connected layer.

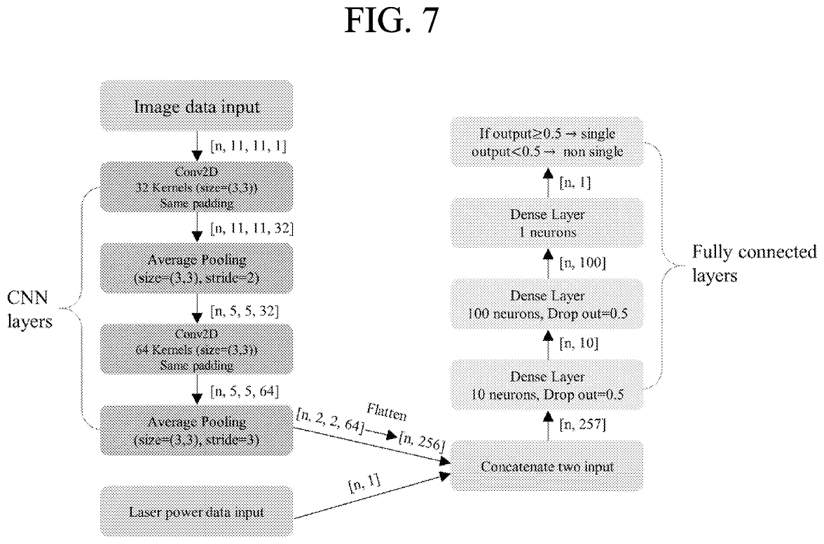

Referring to FIG. 7, in an embodiment of the present disclosure, the convolutional layer may include a first convolutional layer conv2D and a second convolutional layer conv2D. The pooling layer may include a first average pooling layer and a second average pooling layer.

According to embodiments of the present disclosure, the trained artificial neural network model may include a first learning model and a second learning model that are distinguished according to the correlation between input data and laser power irradiated on the target sample.

For example, in the first learning model, image training data may be input to the first convolutional layer, may be input to the fully-connected layer through the first average pooling layer, the second convolutional layer, the second average pooling layer, may be input to the fully-connected layer together with laser power training data corresponding to the image training data, and may output the determination information expected value.

In addition, in the second learning model, the first learning model may perform learning only with image training data except laser power training data.

In the determination of the cropped emitter images from the large-scan image, the second learning model trained by excluding laser power data is used. In the large-scan image, individual emitters are not in focus, resulting in an inaccurate correlation between laser input power and brightness of the focused emitter. The first learning model, which learned the correlation between these as important, becomes unhelpful in determination. Therefore, by excluding laser power training data and performing learning focusing only on the shape and relative brightness of single-photon emitter images, the determination ability of emitters appearing in the large-scan image is increased.

### Embodiment 5: Construction of CNN-Based Deep Learning Model

FIG. 7 is a diagram showing an example of a CNN-based deep learning model designed according to the present disclosure.

The hyper parameters and construction of the CNN model designed in the study related to the present disclosure are as shown in FIG. 7. All hyperparameters of the network architecture or classifier were empirically tuned to values that yielded better results. In this study, the network architecture (hereinafter, the first learning model) receives image training data and laser power training data as input in the form of an 11*11 matrix. The image training data passes through two convolutional layers, image features are extracted by filters in each layer, and the size is compressed through an average pooling process. In the first convolutional layer conv2D, features are intended to be extracted by 32 3*3 kernels. At this time, same padding was used to acquire an output of 11*11*32 dimensions. Thereafter, in the first average pooling layer, data of 11*11*32 dimensions is compressed into data of 5*5*32 dimensions. In the second convolutional layer conv2D, an optimization process was performed using 64 3*3 kernels and same padding. Thereafter, data of 2*2*64 dimensions, which is the final output of the CNN layer (the convolutional layer and the pooling layer), is acquired through the second average pooling layer that is in the same form as the first average pooling layer. This output is unrolled to acquire 256 one-dimensional data and the input laser power training data is combined to finally input data of 257-dimensions to the fully-connected layer. The fully-connected layer receives 257 neurons in the first input and then passes through a layer of 10 neurons and a layer of 100 neurons. At this time, the dropout rate of two layers was set to 0.5. Finally, one output is acquired and binary classification is performed. At this time, the activation function of all layers was set to sigmoid.

In the case of the network architecture that was not trained with laser power data (the second learning model), there is a difference in that data is input to 256 nodes of the fully-connected layer in a state of excluding laser power data, while maintaining the same construction as the network architecture (the first learning model). Besides this, all hyperparameters used during training are the same.

### 6. DEEP LEARNING MODEL EVALUATION METHOD (MODEL TRAINING AND PERFORMANCE EVALUATION METHOD)

In the artificial neural network model used in the present disclosure, binary cross entropy was used as a loss function for binary classification. In addition, in order to evaluate the model of the present disclosure, K-fold cross validation was used to evaluate the performance of the model.

The binary cross entropy is used as the representative loss function used in binary classification and the loss function used in the study related to the present disclosure. When the real class of N data is y and the value predicted by the model is ŷ, the binary cross entropy, which is the loss function of the given model, is expressed as Equation 3 below.

$$B C E ( {y}_{i} , {\hat{y}}_{i} ) = - {\sum }_{i} ( {y}_{i} log {\hat{y}}_{i} + ( 1 - {y}_{i} ) log ( 1 - {\hat{y}}_{i} ) ) \qquad [ Equation 3 ]$$

When the result of binary classification is an actual single-photon emitter and the predicted value exceeds 0.5, it is classified as TP (true positive); otherwise, it is FN (false negative). In addition, when the result of binary classification is not an actual single-photon emitter and the predicted value exceeds 0.5, it is classified as FP (false positive); otherwise, it is TN (true negative). At this time, the accuracy of the model may be defined as in Equation 4.

$$Accuracy = \frac{N ( TP ) + N ( TN )}{N ( TP ) + N ( FP ) + N ( FN ) + N ( TN )} \qquad [ Equation 4 ]$$

where N(x) is the number of events corresponding to x. At this time, x∈{TP,FP,FN,TN}.

In order to perform the k-fold cross validation, a testing set is initially divided into k subsets or folds. Thereafter, (k−1) folds are used as the training set and the remaining one fold is used as the testing set. k test accuracies are acquired by repeating the process until all folds are used once as the testing set. Thereafter, cross validation is performed by averaging these accuracies.

### Embodiment 6: Example of Deep Learning Model Evaluation

In the present disclosure, binary cross entropy was used as the loss function for binary classification. During learning, 30% of training data was used as validation data, and an early stopping method was used to utilize the learning state where the loss of the validation data has a minimum value. It was designed to learn only up to a maximum of 1,000 epochs with patience=20. At this time, a batch size was 32 and an optimizer was tuned to an adaptive moment estimation (ADAM).

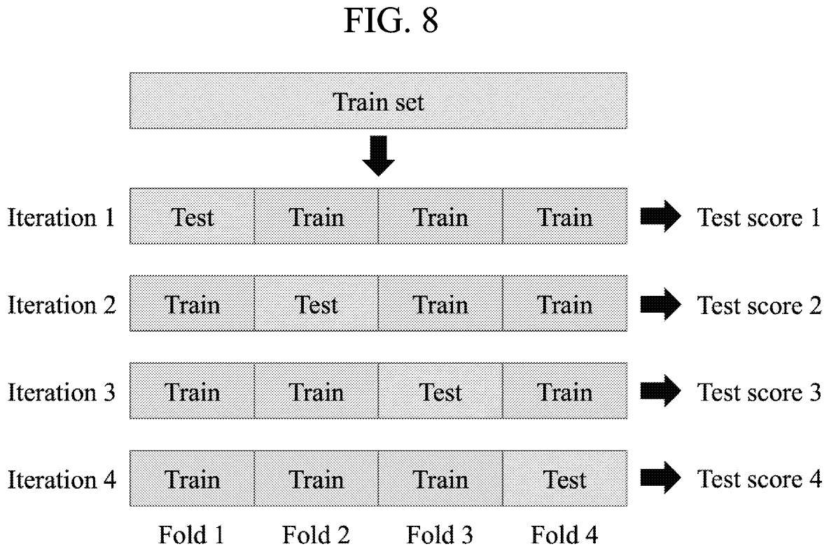

In order to evaluate the model, K-fold cross validation was used to evaluate the performance of the model. Since the number of data is small, k=4 instead of the default k=5 was set to ensure a certain number of testing sets. The performance of the model was evaluated using the average and standard deviation of the test scores for four folds. The K-fold method used in this study is shown in FIG. 8. A total of 380 emitter images extracted from 15 clusters in FIG. 2B were randomly assigned to four folds, with 95 images each.

Tables 2 and 3 show the accuracy of the testing sets and the number of epochs for each fold. The accuracy is calculated as the proportion of data correctly classified by the model over the total number of (training) data in the testing set.

The accuracy of the testing set for each fold is shown in Table 2, as a result of training the deep learning model with training data including laser power training data, and the average accuracy is 0.97. The accuracy of the model was calculated using Equation 4.

TABLE 2

| Fold | Epochs | Accuracy |
|---|---|---|
| 1 | 175 | 0.968 |
| 2 | 383 | 0.968 |
| 3 | 163 | 0.979 |
| 4 | 208 | 0.968 |

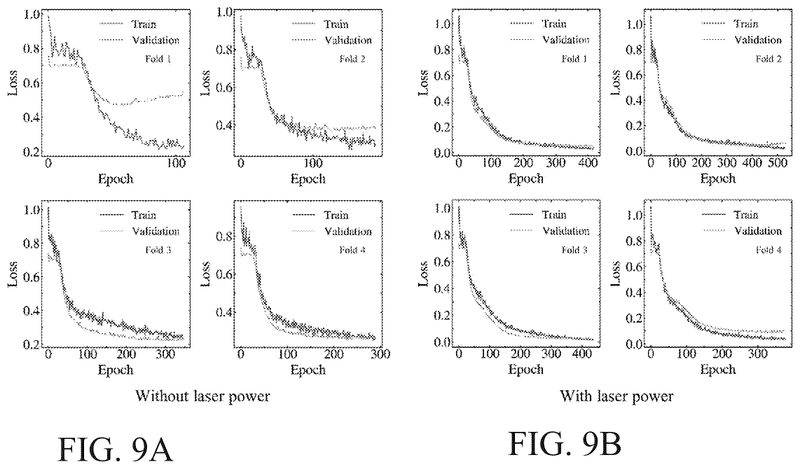

FIG. 9A is a graph showing result values of loss functions of the training set and the testing set according to an epoch in each fold of the training data that does not include laser power. In this manner, it was confirmed that each model was trained appropriately with a continuously decreasing loss function and training was appropriately stopped after finding an optimal epoch.

When a non-focused emitter image was cropped in a large-scan image including one single-photon point light source cluster and the determination was attempted by applying the second learning model (trained by excluding laser power training data), the average accuracy was 0.87. Table 3 shows the accuracy of the testing set for each fold learned by the second learning model. The average accuracy was found to be 0.87.

TABLE 3

| Fold | Epochs | Accuracy |
|---|---|---|
| 1 | 63 | 0.863 |
| 2 | 135 | 0.905 |
| 3 | 276 | 0.853 |
| 4 | 190 | 0.853 |

FIG. 9B is a graph showing result values of loss functions of the training set and the testing set according to an epoch in each fold of the training data including laser power. In this manner, it was confirmed that each model was trained appropriately with a continuously decreasing loss function and training was appropriately stopped after finding an optimal epoch.

### 7. CLASSIFICATION ACCURACY OF DEEP LEARNING MODEL (EMBODIMENT 7)

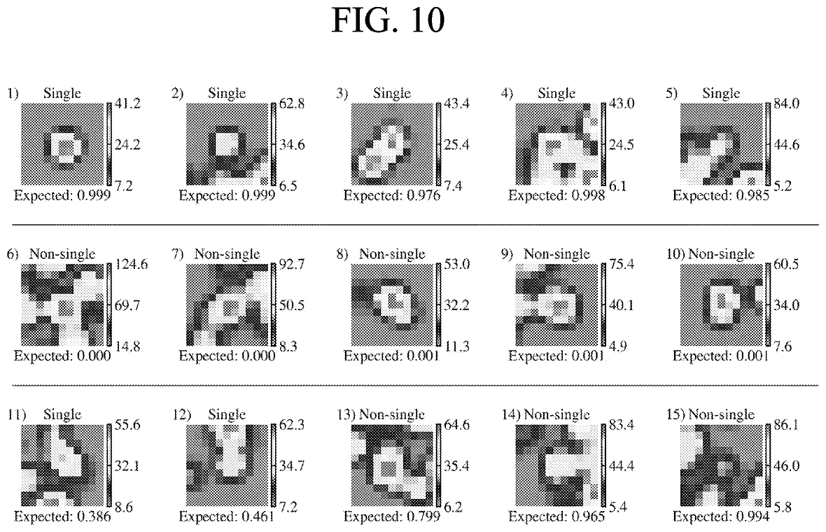

FIG. 10 shows some of the focused emitter images, which are training data. The determination of the single-photon emitter using g⁽²⁾(τ) and the probability of the single-photon emitter of the data determined by the deep learning model are also shown. If the probability of the determination information expected value predicted by the deep learning model (the probability of being the single-photon emitter) was 50% or higher, it was considered that the emitter was determined to be the single-photon emitter.

For example, data from 1) to 5) are data that were determined as actual single-photon emitters using g⁽²⁾(τ) and were also determined as single-photon emitters by the deep learning model. Among 1) and 2), it can be seen that the case of isolated single-photon emitters is accurately determined with high probability. In addition, the results from 3) to 5) confirm that the single-photon emitter can be successfully determined even if it is not isolated but adjacent to other emitters. 6) to 10) are data that accurately determine actual non-single-photon emitters. It can be seen that various types of non-single-photon emitters can be successfully determined even when the non-single-photon emitters are adjacent to surrounding emitters or appear to be relatively point light sources. In addition, it can be seen that non-single-photon emitters, which are difficult to determine intuitively because the brightness thereof is similar to the brightness of single-photon emitters (e.g., 1)), have been successfully determined, as in 8). Meanwhile, data from 11) to 15) are data that failed in determination. That is, this corresponds to a case where the determination result using g⁽²⁾(τ) does not match the determination result using the deep learning model. Cases 11) and 15) where the determination failed despite being a single-photon emitter correspond to cases where it is difficult to find the point light source due to the PSF of the surrounding emitters even though the brightness is similar to that of an actual single-photon emitter. On the other hand, cases 12), 13), and 14) where the determination failed despite of being a non-single-photon emitter are those that have particularly low brightness among non-single-photon emitters and have a form close to a point light source. However, if the determination fails, the determination information expected value (prediction probability) is not close to 0 or 1. Thus, it is possible to confirm the possibility of determining whether or not to trust the prediction of the model, based on the probability provided by the model. As described above, the determination accuracy is 0.97. From the results above, it can be confirmed that the deep learning model successfully learned characteristics such as brightness according to laser power and the point light source form of the emitter, and that even in cases where the determination failed, the prediction probability includes information about the determination failure.

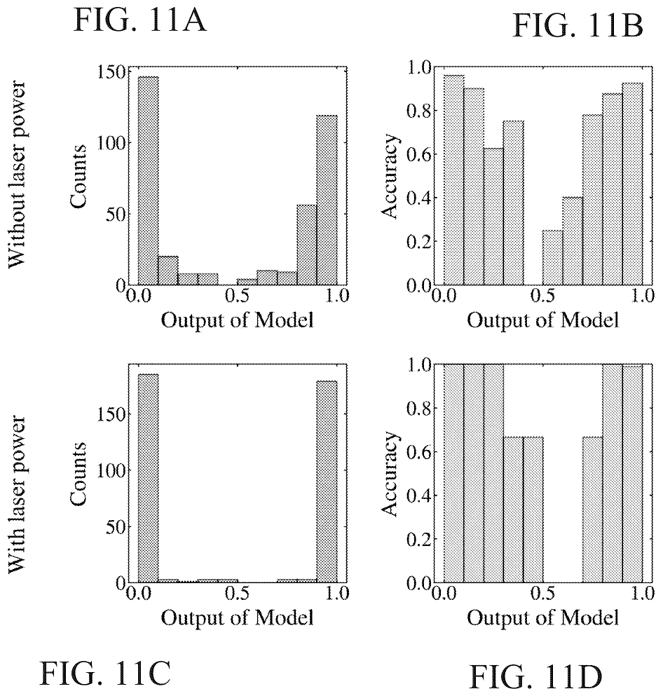

FIGS. 11A-11D are graphs showing the distribution of the results of data determination of the deep learning model and the ratio of the resulting accuracy so as to determine the actual accuracy according to the prediction probability.

At this time, when the prediction probability is less than 0.5, the accuracy is obtained by dividing the number of non-single-photon emitter data determined with real g⁽²⁾(0) by the total number of data, and when the prediction probability is greater than 0.5, the accuracy is obtained by dividing the number of single-photon emitter data determined with real g⁽²⁾(0) by the total number of data within the probability range. It can be confirmed from FIG. 11A that most of the data are concentrated in the probability values of 0 or 1 and a very small number of data are distributed in the center. In addition, as shown in FIG. 11B, it can be confirmed that as the probability value is closer to 0 or 1, the accuracy is generally higher, and as the probability value is closer to the center, i.e., 0.5, the accuracy is lowered. This result can verify that as the prediction probability is closer to 0 or 1, the reliability increases.

Meanwhile, input data based on non-focused emitter images (emitter images cropped from the large-scan images) were acquired, determination was attempted using the second learning model trained by excluding laser power training data, and the average accuracy was found to be 0.87. It was also confirmed that this training data also conducted appropriate learning through analysis of loss functions.

That is, it can be concluded that this is an appropriate model capable of determining whether an emitter is a single-photon emitter, based only on the form and relative brightness data, even without laser power training data. However, it can be confirmed that the accuracy is lower than when trained with the laser power training data, which confirms that the laser power can serve as feature data as training data and improve the performance of the model. To find out the real accuracy according to the prediction probability, the graphs showing the distribution of the results of the data determination of the model and the ratio of the accuracy thereof are shown in FIGS. 11C and 11D. This result can again verify that as the prediction probability is closer to 0 or 1, the reliability increases.

Finally, the process of determining whether the emitter is a single-photon emitter using the second learning model (excluding laser power) in non-focused emitter images (emitter images cropped from the large-scan image) (=the process of determining emitters that are not in the same focal plane in the large-scan image by using only the image) was repeated for clusters 12 to 15.

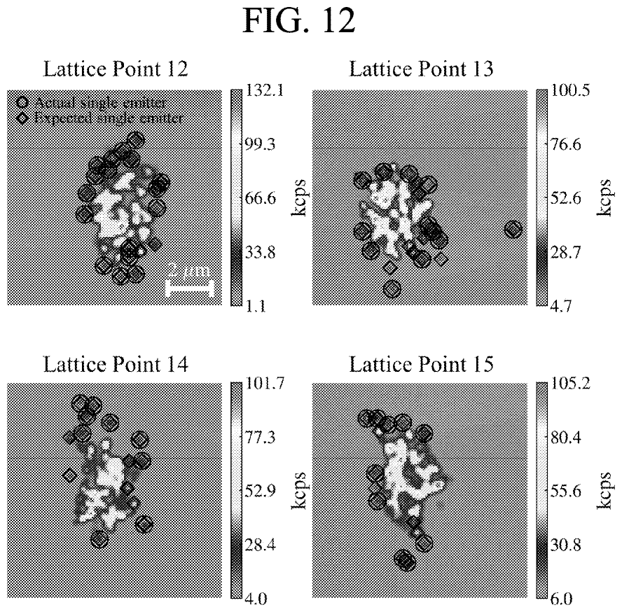

In clusters 12 to 15, there are a total of 106 single-photon emitters and non-single-photon emitters confirmed through g⁽²⁾(τ), and when the corresponding data were determined using the second learning model, the accuracy of 0.838 was obtained. FIG. 12 shows the actual single photon emitter together with the single photon emitter predicted by the deep learning model, and it can be confirmed that most of them are judged to be the same. Through the determination accuracy and FIG. 12, it can be confirmed that single-photon emitters can be effectively determined even in emitter images cropped from large-scan images (non-focused emitter images).

In the case of point light sources where more than one emitter is gathered together to emit light, it is difficult to easily determine whether the light source is single/non-single with the naked eye in the image. In order to perform an HBT experiment that requires a considerable amount of time, it is necessary to select point light sources that are likely to be single-photon emitters from among a plurality of emitters (tens to hundreds of thousands of emitters) observed in the image. At this time, a method is used to re-scan the point light source images with a narrow range of high resolution to observe the form of the point light sources in detail, but this also requires a considerable amount of time and labor. Thereafter, an HBT experiment is performed by selecting regions that appear to be single-photon emitters from a narrow range of high-resolution scan images.

Referring to FIG. 12, in the case of spots in the embodiment of the present disclosure, it can be confirmed that the real spots of the actual single-photon emitters are all included in the predicted spots. Therefore, when finding the actual single-photon emitter, the deep learning model can be used to preferentially scan and find spots that are worth checking, which can significantly reduce time and labor compared to existing methods.

### 8. DEEP LEARNING MODEL ANALYSIS AND RESULTS

### Embodiment 8: Comparison of Output Differences of Deep Learning Models

In order to determine whether CNN layers (convolutional layers and pooling layers) are of practical help in determining single-photon emitters, the difference in the final outputs of the CNN layers when single-/non-single-photon emitter data were input was observed.

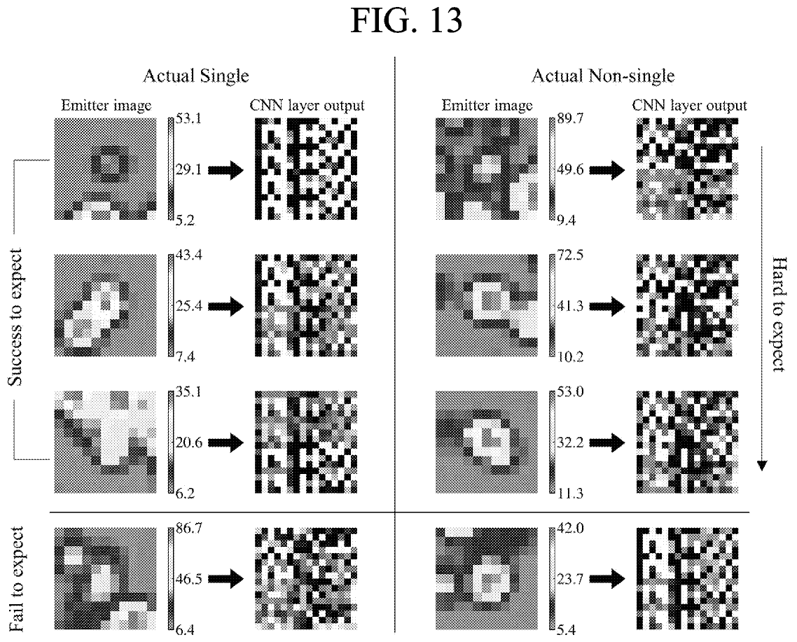

FIG. 13 is a diagram showing a final output of a CNN layer in a case where the determination for representative data succeeds and a case where the determination for representative data fails. Since the final output is in the form of (2, 2, 64), the final output was rearranged into the form of (16, 16) for intuitive determination.

As a result of observing the output of data expected by a single-photon emitter and the output of data expected by a non-single-photon emitter, it can be confirmed that there was a difference in the lower part of the output. It is also observed that differences in the regularity of specific patterns are prominent in the images. That is, it can be seen that there is a difference in the output of different classes, and accordingly, it can be seen that the CNN layer serves to identify the difference between single/non-single and output the abstract difference in the output results.

### CONCLUSION

The embodiments of the present disclosure suggest that single-photon emitters in the medium can be efficiently and accurately determined using only single-photon point light source images (diamond NV center images using the confocal fluorescence microscopy) and data based on laser power, without conducting HBT experiments, and also demonstrate that the CNN-based deep learning model can be adopted as a model with excellent performance in determination.

According to the embodiments of the present disclosure, when learning is performed using focused emitter images (1 μm×1 μm) and laser power training data (first learning model), the determination is possible with an accuracy of 97%.

According to the embodiments of the present disclosure, when the process of focusing on individual emitters is omitted and the CNN-based deep learning model is applied to the emitter image (non-focused emitter image, 1 μm×1 μm) cropped from the large-scan image (10 μm×10 μm) (second learning model), the determination can be made with a satisfactory accuracy of 84%. In this case, the time efficiency improvement of about 90% is possible, as shown in FIG. 1E.

Therefore, the embodiments of the present disclosure can greatly increase time and labor efficiency in most studies related to single-photon emitters, which have recently been actively studied in quantum information.

### 9. ADDITIONAL CONSIDERATIONS

The methods according to embodiments of the present disclosure may be implemented in the form of program commands that are executable through a variety of computer means and may be recorded on a computer-readable recording medium. The computer-readable recording medium may include program commands, data files, data structures, etc. alone or in combination. The program commands recorded on the computer-readable recording medium may be specially designed and configured for the embodiments or may be known and available to those of ordinary skill in the art of computer software. Examples of the computer-readable recording medium may include magnetic media, such as hard disk, floppy disk, and magnetic tape, optical media, such as compact disc read-only memory (CD-ROM) and digital versatile disc (DVD), magneto-optical media, such as floptical disk, and hardware devices specially configured to store and execute program commands, such as ROM, RAM, and flash memory. Examples of the program commands may include not only machine language code generated by a compiler but also high-level language code that is executable using an interpreter by a computer. The hardware devices may be configured to operate as one or more software modules to perform the operations of the embodiments, and vice versa.

The software may include a computer program, code, instructions, or a combination of one or more thereof, and may configure a processor to operate as desired or may instruct the processor independently or collectively. The software and/or data may be permanently or temporarily embodied in any type of machine, component, physical device, virtual equipment, computer storage media or device, or transmitted signal waves, for interpretation by a processing device or for providing instructions or data to a processing device. The software may be distributed in network-connected computer systems and stored or executed in a distributed manner. The software and data may be stored on one or more computer-readable recording media.

The above description is only an example of the technical idea of the present disclosure, and those of ordinary skill in the art will appreciate that various modifications and variations may be made without departing from the essential characteristics of the present disclosure. For example, appropriate results may be achieved even when the technologies described above are performed in an order different from the methods described above, and/or the components of the systems, structures, devices, circuits described above are coupled or combined in a manner different from the methods described above or are replaced or substituted for other components or equivalents.

Therefore, the embodiments disclosed in the present disclosure are not intended to limit the technical idea of the present disclosure but to explain the present disclosure, and the scope of the technical idea of the present disclosure is not limited by these embodiments. The scope of protection of the present disclosure should be interpreted by the appended claims, and all technical ideas within the scope equivalent thereto should be interpreted as being included in the scope of the rights of the present disclosure.

What is claimed is:

1. A method for determining a single-photon emitter based on deep learning, performed by at least one electronic device, the method comprising:
acquiring input data based on a single-photon point light source image;
generating determination information expected values by inputting the input data to a trained artificial neural network model; and
determining whether an emitter providing the single-photon point light source image is a single-photon emitter or a non-single-photon emitter, based on the determination information expected values.

2. The method of claim 1, wherein the single-photon point light source image includes an image acquired using confocal fluorescence microscopy, scanning tunneling microscopy (STM), and/or nanoscale-magnetic resonance imaging (nano-MRI).

3. The method of claim 1, wherein the single-photon point light source include at least one of isolated single atoms, single molecules, single dye molecules, and/or point defects in solids.

4. The method of claim 1, wherein the input data is generated based on an image of a small area having a photon count rate of a preset standard within a preset area in a large-scan image including one single-photon point light source cluster.

5. The method of claim 1, further comprising training the artificial neural network model,
wherein the training of the artificial neural network model comprises constructing image training data based on the single-photon point light source image.

6. The method of claim 5, wherein the training of the artificial neural network model further comprises constructing laser power training data based on laser power irradiated on a target sample.

7. The method of claim 5, wherein the constructing of the image training data comprises:
generating an image of a small area having a photon count rate of a preset standard within a preset area in a large-scan image including one single-photon point light source cluster;
removing background noise from the generated image;
determining and labeling whether the emitter is the single-photon emitter or the non-single-photon emitter; and
performing normalization to a normally distributed value.

8. The method of claim 7, wherein the generated image includes an image focused on an individual emitter, and
the image focused on the individual emitter is an image of a small area raster-scanned again based on a pixel corresponding to a local maximum of a photon count rate of the individual emitter in a raster-scanned image for the individual emitter within the one single-photon point light source cluster.

9. The method of claim 1, wherein the trained artificial neural network model comprises a convolutional neural network (CNN)-based deep learning model.

10. The method of claim 1, wherein the trained artificial neural network model comprises a convolutional layer, a pooling layer, and/or a fully-connected layer.

11. The method of claim 6, wherein the trained artificial neural network model comprises:
a first learning model that is distinguished according to a correlation between the input data and the laser power irradiated on the target sample; and
a second learning model that is not distinguished according to the correlation between the input data and the laser power irradiated on the target sample.

12. The method of claim 6, wherein the training of the artificial neural network model comprises constructing first laser power training data learned by setting the laser power irradiated on the target sample to first laser power and second laser power training data learned by setting the laser power irradiated on the target sample to second laser power, and
the first laser power and the second laser power have different power values.

13. The method of claim 1, wherein the trained artificial neural network model is trained using a binary cross-entropy loss function.

14. The method of claim 1, wherein the trained artificial neural network model determines whether the determination information expected values are appropriate by using K-fold cross validation, where k is a natural number greater than or equal to 3, and
the K-fold cross validation is performed by randomly classifying training data into k-folds and using k−1 folds as a training set and the remaining one fold as a testing set.

15. An electronic device for determining a single-photon emitter based on deep learning, the electronic device comprising:
at least one memory; and
at least one processor configured to:
acquire input data based on a single-photon point light source image;
generate determination information expected values by inputting the input data to a trained artificial neural network model; and
determine whether an emitter providing the single-photon point light source image is a single-photon emitter or a non-single-photon emitter, based on the determination information expected values.

16. A method for determining a single-photon emitter based on deep learning, performed by at least one electronic device, the method comprising:
training an artificial neural network model;
wherein the training of the artificial neural network model comprises:
acquiring first laser power training image data constructed by setting laser power irradiated on a target sample to the first laser power, and acquiring second laser power training image data constructed by setting the laser power irradiated on the target sample to second laser power;
generating a partial image of a small area having a photon count rate of a preset standard within a preset area, which is at least a part of the first laser power training image data and the second laser power training image data;
removing background noise from the partial image; and
determining and labeling whether an emitter is a single-photon emitter or a non-single-photon emitter,
acquiring an image based on photons emitted from an emitter to be determined;
acquiring input data based on the image;
generating determination information expected values by inputting the input data to the artificial neural network model; and
determining whether the emitter is a single-photon emitter or a non single-photon emitter, based on the determination information expected values.

17. The method of claim 16, wherein the trained artificial neural network model is trained using a binary cross-entropy loss function.

18. The method of claim 16, wherein the trained artificial neural network model determines whether the determination information expected values are appropriate by using K-fold cross validation, where k is a natural number greater than or equal to 3, and
the K-fold cross validation is performed by randomly classifying training data into k-folds and using k−1 folds as a training set and the remaining one fold as a testing set.

19. The method of claim 16, wherein the trained artificial neural network model comprises a convolutional layer, a pooling layer, and/or a fully-connected layer.

20. The method of claim 16, wherein the trained artificial neural network model comprises:
a first learning model that is distinguished according to a correlation between the input data and the laser power irradiated on the target sample; and
a second learning model that is not distinguished according to the correlation between the input data and the laser power irradiated on the target sample.
